(19) United States
(12) Patent Application Publication
(10) Pub. No.: US 2014/0064688 A1
(43) Pub. Date: Mar. 6, 2014

(54) OPTICAL FIBER ADAPTER

(71) Applicants: Sung-An LIN, Miaoli County (TW); Sung-Chi LIN, Miaoli County (TW)

(72) Inventors: Sung-An LIN, Miaoli County (TW); Sung-Chi LIN, Miaoli County (TW)

(73) Assignee: EZONTEK TECHNOLOGIES CO., LTD., New Taipei City (TW)

(21) Appl. No.: 13/602,635

(22) Filed: Sep. 4, 2012

(51) Int. Cl. G02B 6/00

(52) U.S. Cl. 385/134

(57) ABSTRACT

The present disclosure provides an optical fiber adapter. The optical fiber adapter includes a main body, a plate and a key protrusion. The main body has an accommodation room defined by a first wall, a second wall, a third wall and a fourth wall, wherein the first wall faces the third wall and connects with the second and fourth walls. The accommodation room has an opening in an axial direction. A breach is formed in the third wall. The plate is positioned in the breach of the third wall. The key protrusion is formed on the plate and in the accommodation room. When an optical fiber connector is inserted into the accommodation room, the key protrusion will be positioned in a key indentation formed on the optical fiber connector.

### BACKGROUND

1. Technical Field

The invention relates to an optical fiber adapter, and more particularly, to an optical fiber adapter with key protrusions.

2. Description of the Related Art

Optical fibers terminated by connectors and the adapters which are adapted to receive these connectors are an important part of virtually any fiber optical communication systems. For example, such connectors and adapters may be used to interconnect fiber segments to create longer lengths, to connector optical fiber to active or passive devices, etc. However, in some cases, for example for security reasons or in order to better manage a telecommunications network, it is desired to physically limit the insertion of a connector into a particular adapter, and as a result prevent the transmission of data via that connector and adapter.

Referring to FIG. 1, in order to solve the above problem, some manufactures have arranged some key protrusions 120 in the accommodation room 110 of the optical fiber adapter 100. Only the optical fiber connector 200 illustrated in FIG. 2 that has corresponding indentations 220 for receiving the key protrusions 120 may be inserted into the optical fiber adapter 100.

However, it is required to make various molds in order to form the optical fiber adapters 100 that have different key protrusions 120. This will increase production cost of the optical fiber adapters 100.

Accordingly, there exists a need to provide a solution to solve the aforesaid problems.

### SUMMARY

The present disclosure provides an optical fiber adapter.

In one embodiment, the optical fiber adapter of the present disclosure includes a main body, a plate and a key protrusion. The main body has an accommodation room defined by a first wall, a second wall, a third wall and a fourth wall, wherein the first wall faces the third wall and connects with the second and fourth walls. The accommodation room has an opening in an axial direction. A breach is formed in the third wall. The plate is positioned in the breach of the third wall. The key protrusion is formed on the plate and in the accommodation room. When an optical fiber connector is inserted into the accommodation room, the key protrusion will be positioned in a key indentation formed on the optical fiber connector.

The foregoing, as well as additional objects, features and advantages of the disclosure will be more readily apparent from the following detailed description, which proceeds with reference to the accompanying drawings.

### BRIEF DESCRIPTION OF THE DRAWINGS

FIG. 1 is an elevated perspective view of a conventional optical fiber adapter with key protrusions.

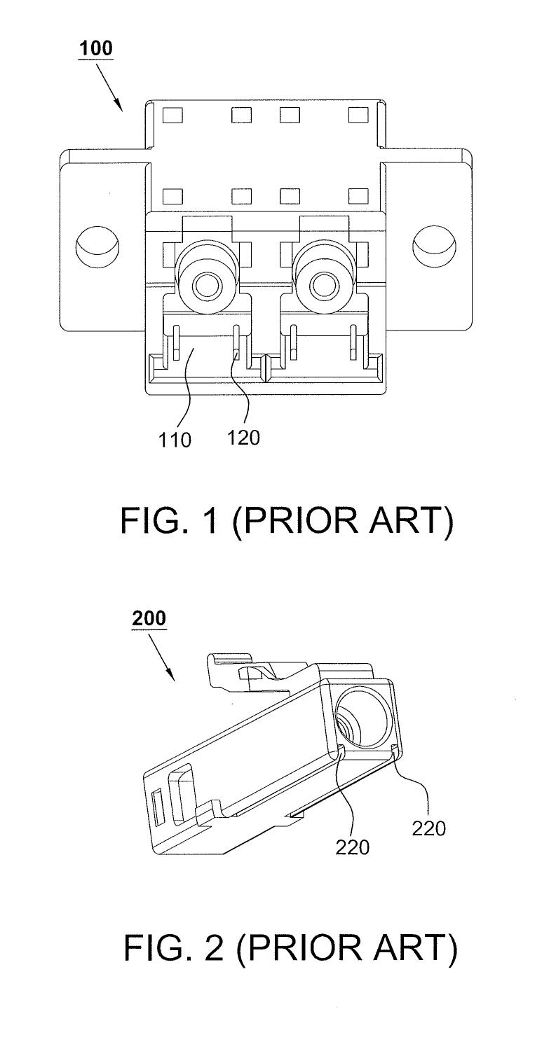

FIG. 2 illustrates a conventional optical fiber connector that may be inserted into the optical fiber adapter of FIG. 1.

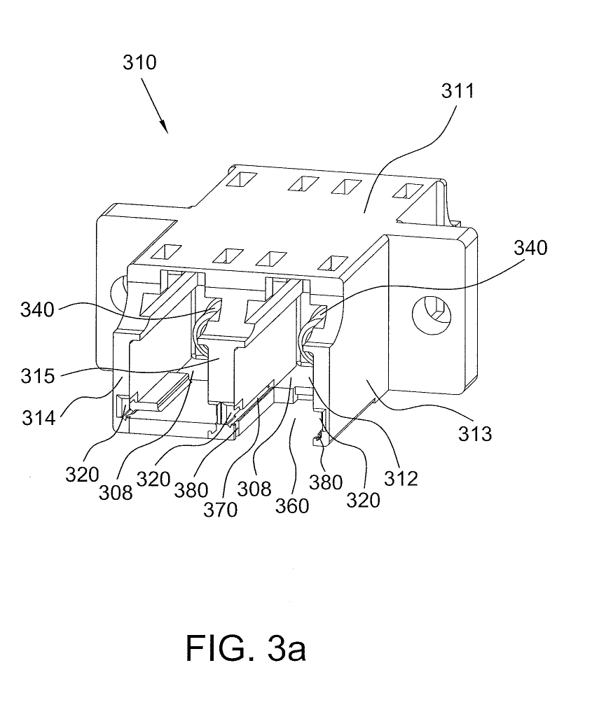

FIGS. 3a and 3b are different perspective views of the main body of the optical fiber adapter of the present disclosure.

FIG. 3c is a side view of the main body of the optical fiber adapter of the present disclosure.

FIGS. 4a and 4b are different perspective views of the plate of the optical fiber adapter of the present disclosure.

FIG. 5 illustrates the main body and plate of the optical fiber adapter according to the present disclosure.

FIG. 6 is an elevated perspective view of the optical fiber adapter of the present disclosure.

FIG. 7 illustrates a conventional optical fiber connector that may be inserted into the optical fiber adapter of FIG. 6.

### DETAILED DESCRIPTION OF THE PREFERRED EMBODIMENT

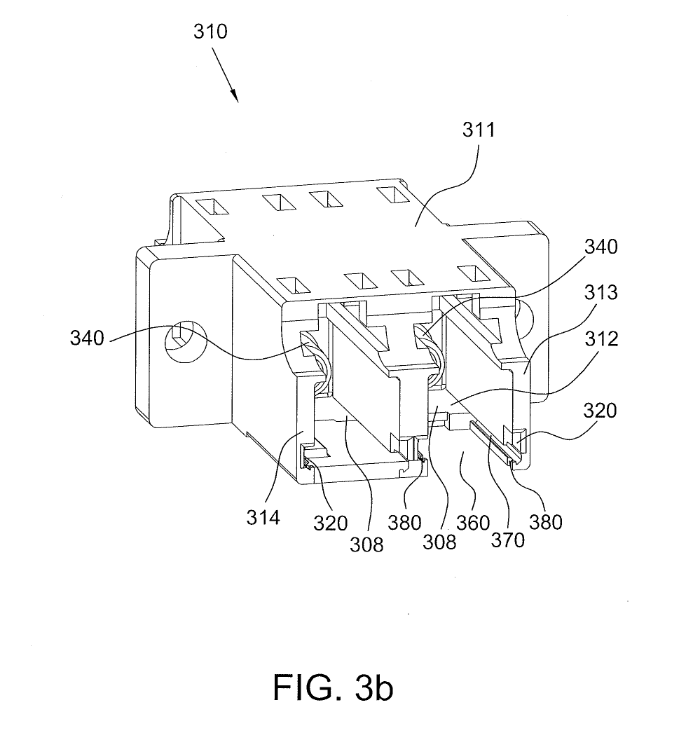

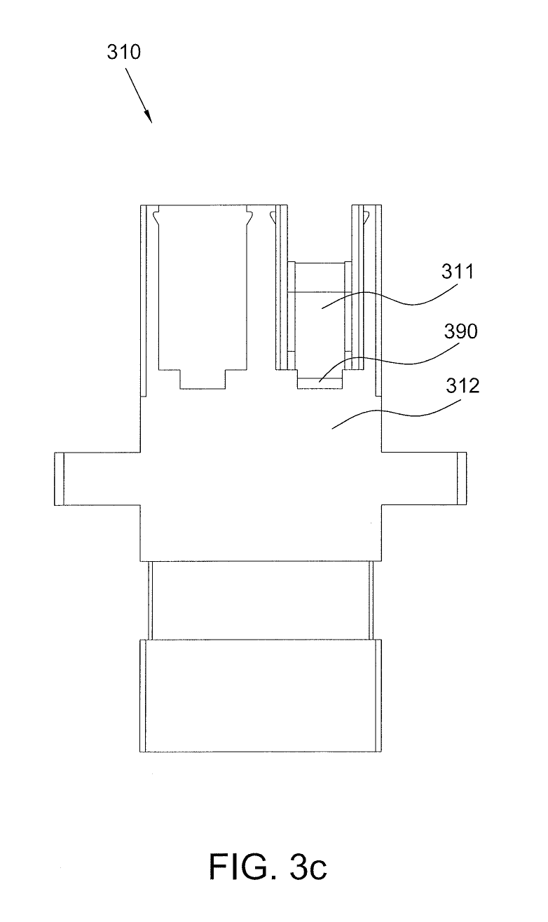

Referring to FIGS. 3a to 3c, the optical fiber adapter according to the present disclosure includes a plastic main body 310. The main body 310 is substantially rectangular and has an accommodation room defined by a top side-wall 311, a bottom side-wall 312, a right side-wall 313 and a left side-wall 314, wherein the top side-wall 311 faces the bottom side-wall 312 and connects with the right side-wall 313 and left side-wall 314. The accommodation room is divided into two halves by a compartment wall 315 that is parallel to the right side-wall 313 and left side-wall 314 and connects with the top side-wall 311 and bottom side-wall 312. The half of the accommodation room defined by the top side-wall 311, bottom side-wall 312, compartment wall 315 and right side-wall 313 is named as the right accommodation room and the other half of the accommodation room defined by the top side-wall 311, bottom side-wall 312, compartment wall 315 and left side-wall 314 is named as the left accommodation room. Each of the right and left accommodation rooms has an opening 308 in an axial direction. A pair of indentations 320 is arranged in the left accommodation room and on the left side-wall 314 and compartment wall 315, respectively. Similarly, the indentations 320 are also arranged in the right accommodation room and on the right side-wall 313 and compartment wall 315, respectively. Two hollow cylinders 340 are axially positioned within the right and left accommodation rooms respectively to receive the ferrules of the optical fiber connectors.

In addition, a breach 360 is formed in the bottom side-wall 312 and within the right accommodation room. The breach 360 is in communication with the opening 308 of the right accommodation room. Two connecting portions 370 are axially formed in the right accommodation room and on the right side-wall 313 and compartment wall 315, respectively. Two snapping portions 380 are formed in the right accommodation room and on the right side-wall 313 and compartment wall 315, respectively. An indentation 390 is formed outside the right accommodation room and on the bottom side-wall 312. The indentation 390 is in communication with the breach 360. In one embodiment, the snapping portions 380 are indentations.

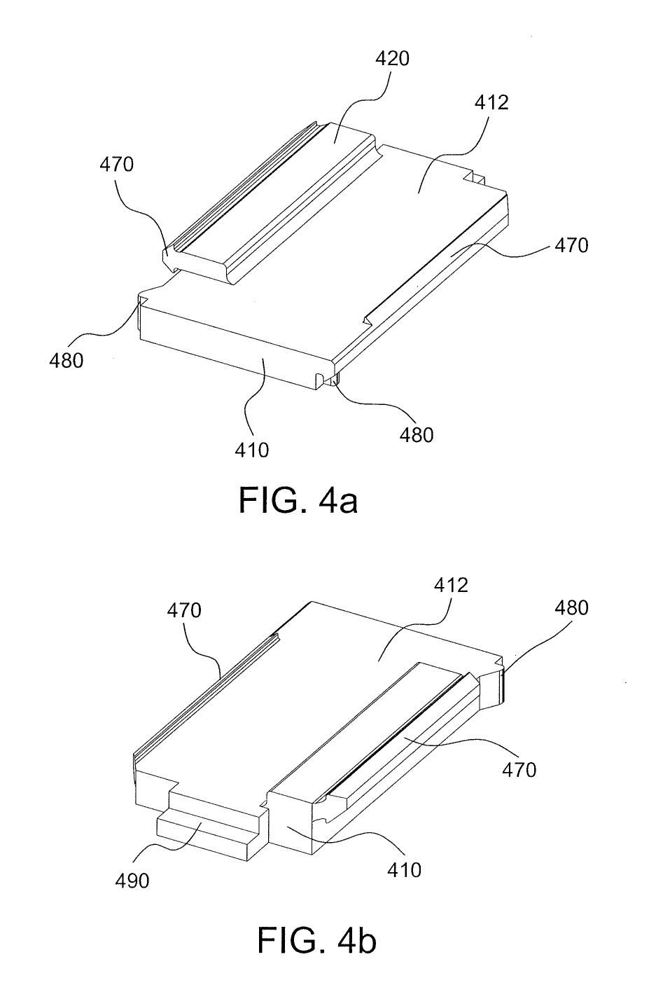

Referring to FIGS. 4a and 4b, the optical fiber adapter according to the present disclosure further includes a plate 410 and two connecting portions 470 axially formed on the plate 410. The connecting portions 470 are positioned corresponding to the connecting portions 370 formed on the right side-wall 313 and compartment wall 315, respectively. Two snapping portions 480 are formed on the plate 410 and are positioned corresponding to the snapping portions 380 formed on the right side-wall 313 and compartment wall 315, respectively. A protruding portion 490 extends from a side surface of the plate 410. In addition, at least one key protrusion 420 is axially formed on an upper surface 412 of the plate 410. In one embodiment, at least one of the connecting portions 470 extends directly from the key protrusion 420. The snapping portions 480 are protrusions.

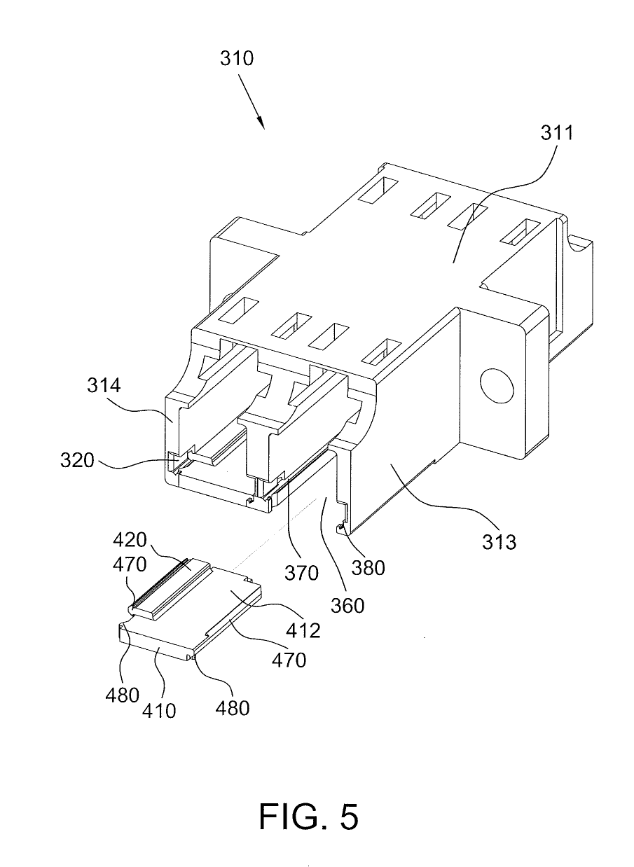

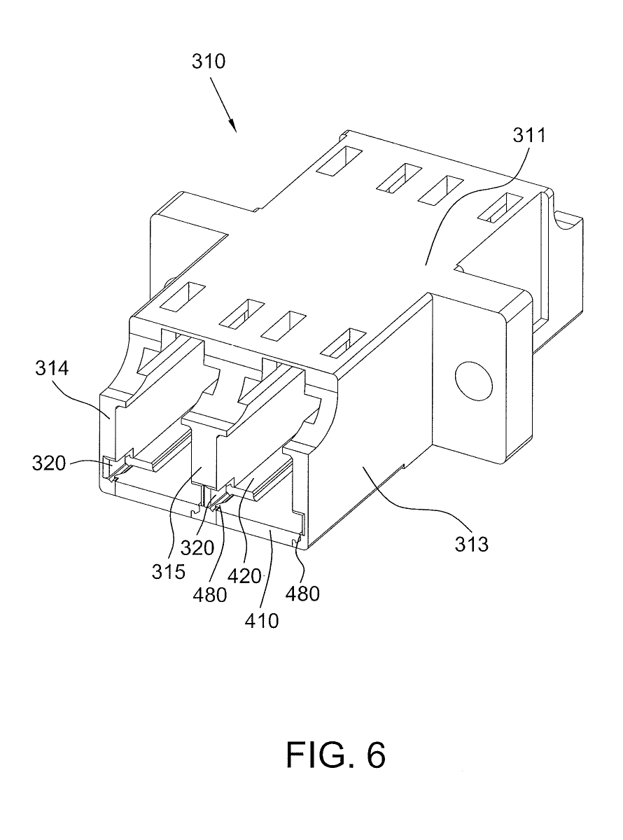

Referring to FIGS. 5 and 6, when desiring to attach the plate 410 to the main body 310, the plate 410 is inserted into the breach 360 formed on the bottom side-wall 312, and the connecting portions 470 of the plate 410 are connected with the connecting portions 370 of the main body 310, respectively. In one embodiment, the connecting portions 470 are wedge-shaped protrusions and the connecting portions 370 are slots that have the shapes corresponding to the shapes of the wedge-shaped protrusions 470, respectively. When the plate 410 continues to be pushed into the main body 310, the protrusions 470 will slide in the slots 370, respectively. Finally, the snapping portions 480 on the plate 410 and the snapping portions 380 on the main body 310 will be snapped into each other, respectively. Furthermore, the protruding portion 490 extending from the plate 410 will be positioned in the indentation 390 on the bottom side-wall 312.

According to the present disclosure, it may prevent the plate 410 from being pulled out of the main body 310 when the snapping portions 480 and the snapping portions 380 on the main body 310 are snapped into each other. Furthermore, since the protruding portion 490 extending from the plate 410 is positioned under the bottom side-wall 312, it may prevent the plate 410 from being levered up.

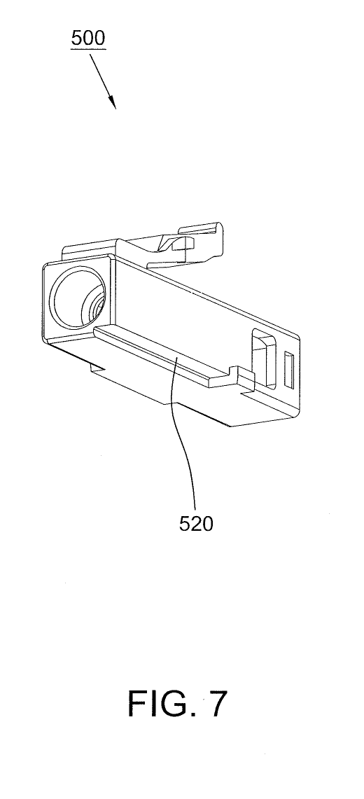

When the plate 410 is attached to the main body 310, the key protrusion 420 will be positioned within the right accommodation room of the main body 310. Therefore, only the optical fiber connectors that have corresponding indentations for receiving the key protrusion 420 may be inserted into the right accommodation room of the main body 310. Referring to FIG. 7, the optical fiber connector 500 is provided with a key indentation 520 thereon for receiving the key protrusion 420. Therefore, the optical fiber connector 500 may be inserted into the main body 310 of the optical fiber adapter of the present disclosure.

According to the present disclosure, if one would like to make optical fiber adapters with various key protrusions 420, he/she may attach the plates 410 provided with the key protrusions 420 to the main bodies 310. Therefore, it is required only one set of molds of making the main body 310 and several sets of molds of making the plates 410. It should be understood that the molds of making the main body 310 are much more expensive than the molds of making the plate 310. Therefore, the total production cost of manufacturing the optical fiber adapters with various key protrusions according to the present disclosure is lower than that of manufacturing conventional ones.

It should be noted that although the present disclosure is illustrated with duplex adapters, simplex or other multiplex can also be adopted to achieve the present disclosure.

Although the preferred embodiments of the disclosure have been disclosed for illustrative purposes, those skilled in the art will appreciate that various modifications, additions and substitutions are possible, without departing from the scope and spirit of the disclosure as disclosed in the accompanying claims.

What is claimed is:

1. An optical fiber adapter, comprising:
a main body having an accommodation room defined by a first wall, a second wall, a third wall and a fourth wall, the first wall facing the third wall and connecting with the second and fourth walls, wherein the accommodation room has an opening in an axial direction, and a breach is formed in the third wall;
a plate positioned in the breach of the third wall; and
a key protrusion formed on the plate and in the accommodation room,
wherein when an optical fiber connector is inserted into the accommodation room, the key protrusion will be positioned in a key indentation formed on the optical fiber connector.

2. The optical fiber adapter as claimed in claim 1, wherein a first snapping portion is formed on the main body, the optical fiber adapter further comprising:
a second snapping portion formed on the plate, wherein the first and second snapping portions are snapped into each other.

3. The optical fiber adapter as claimed in claim 2, wherein the first snapping portion is formed on the second wall of the main body.

4. The optical fiber adapter as claimed in claim 3, wherein a third snapping portion is formed on the fourth wall of the main body, the optical fiber adapter further comprising:
a fourth snapping portion formed on the plate, wherein the third and fourth snapping portions are snapped into each other.

5. The optical fiber adapter as claimed in claim 1, wherein the key protrusion is axially positioned on the plate.

6. The optical fiber adapter as claimed in claim 1, further comprising:
a first connecting portion axially formed on the main body; and
a second connecting portion axially formed on the plate,
wherein the second connecting portion is connected with the first connecting portion.

7. The optical fiber adapter as claimed in claim 6, wherein the first connecting portion is a slot, and the second connecting portion is a protrusion positioned within the first connecting portion.

8. The optical fiber adapter as claimed in claim 7, wherein the second connecting portion is a wedge-shaped protrusion.

9. The optical fiber adapter as claimed in claim 7, wherein the second connecting portion extends from the key protrusion.

10. The optical fiber adapter as claimed in claim 6, wherein the first connecting portion is formed on the second wall of the main body.

11. The optical fiber adapter as claimed in claim 2, wherein an indentation is formed on the third wall of the main body, the optical fiber adapter further comprising:
a protruding portion extending from the plate, wherein the protruding portion is positioned in the indentation on the third wall.

12. The optical fiber adapter as claimed in claim 2, wherein the first snapping portion is an indentation and the second snapping portion is a protrusion.

13. The optical fiber adapter as claimed in claim 4, wherein the first and third snapping portions are indentations, and the second and fourth snapping portions are protrusions.
